(19) United States
(12) Patent Application Publication
(10) Pub. No.: US 2025/0214672 A1
(43) Pub. Date: Jul. 3, 2025

(54) VEHICLE

(71) Applicant: KAWASAKI MOTORS, LTD., Hyogo (JP)

(72) Inventors: Kenta NAKAMURA, Lincoln, NE (US); Norikazu MATSUMURA, Akashi-shi (JP)

(73) Assignee: KAWASAKI MOTORS, LTD., Hyogo (JP)

(21) Appl. No.: 18/398,376

(22) Filed: Dec. 28, 2023

(51) Int. Cl. B62K 19/40; B62K 5/08; B62K 19/46; B62K 21/12

(52) U.S. Cl. CPC B62K 19/40; B62K 5/08; B62K 19/46; B62K 21/125

(57) ABSTRACT

A vehicle includes: a vehicle body; a handle provided on an upper part of the vehicle body; and a carrier provided in the front of the handle or in the rear relative to the handle. The carrier includes a body part for placing a load and an attachment bar protruding toward a handle side from the body part.

### BACKGROUND

### Technical Field

The present disclosure relates to a vehicle suitable for traveling on an irregular ground, typified by an all terrain vehicle (ATV).

### Background Art

As a saddle-type four-wheel vehicle, a saddle-type four-wheel vehicle described in US 2005/150706 A1 is known. This saddle-type four-wheel vehicle is provided with a carrier in the front of a handle and in the rear of a seat. Use of the carrier enables an occupant to travel with a load in the saddle-type four-wheel vehicle. The carrier is also used as an attachment place of an auxiliary apparatus. A GPS, a camera, a light, a speaker, and the like are examples of the auxiliary apparatus. However, in the saddle-type four-wheel vehicle described in US 2005/150706 A1, when the auxiliary apparatus is attached to the carrier, the auxiliary apparatus becomes an obstacle, and a space for the load is reduced. Therefore, in some cases, the loading amount of the load is sacrificed. An attempt to ensure the loading amount of the load sometimes makes it difficult to attach the auxiliary apparatus to the carrier, making the auxiliary apparatus unusable.

### SUMMARY

The present disclosure has been made in view of the above circumstances, and an object of the present disclosure is to provide a vehicle that allows an auxiliary apparatus to be attached to a carrier without any difficulty and to be used without sacrificing the loading amount of a load.

In order to solve the above problems, a vehicle according to one aspect of the present disclosure includes: a vehicle body; a handle provided on an upper part of the vehicle body; and a carrier provided in a front of the handle or in a rear relative to the handle, in which the carrier includes a body part for placing a load and an attachment bar protruding toward a handle side from the body part.

### BRIEF DESCRIPTION OF THE DRAWINGS

FIG. 1 is a side view of a saddle-type four-wheel vehicle according to one embodiment of the present disclosure.

FIG. 2 is a plan view of the saddle-type four-wheel vehicle.

FIG. 3 is a front perspective view (perspective view viewed from diagonally front) of the saddle-type four-wheel vehicle.

FIG. 4 is a front perspective view (perspective view viewed from diagonally rear) of the saddle-type four-wheel vehicle.

FIG. 5 is a front plan view of the saddle-type four-wheel vehicle.

FIG. 6 is a front perspective view (perspective view viewed from diagonally front) of the saddle-type four-wheel vehicle in a state where a carrier cover is removed from a front carrier.

FIG. 7 is a front plan view of the saddle-type four-wheel vehicle in a state where the carrier cover is removed from the front carrier.

FIG. 8 is a front plan view of the saddle-type four-wheel vehicle for describing a rotation region of a handlebar.

FIG. 9 is a schematic side view illustrating an example of a use state of the front carrier.

### DETAILED DESCRIPTION

An embodiment of a vehicle of the present disclosure will be described below with reference to the drawings. In the drawings, front, rear, left, and right directions indications are given, and these directions coincide with directions viewed from a driver on the vehicle. Unless otherwise specified, when “front-rear direction” and “left-right direction” are simply mentioned, they are based on the direction indications.

### [Overall Configuration of Saddle-Type Four-Wheel Vehicle]

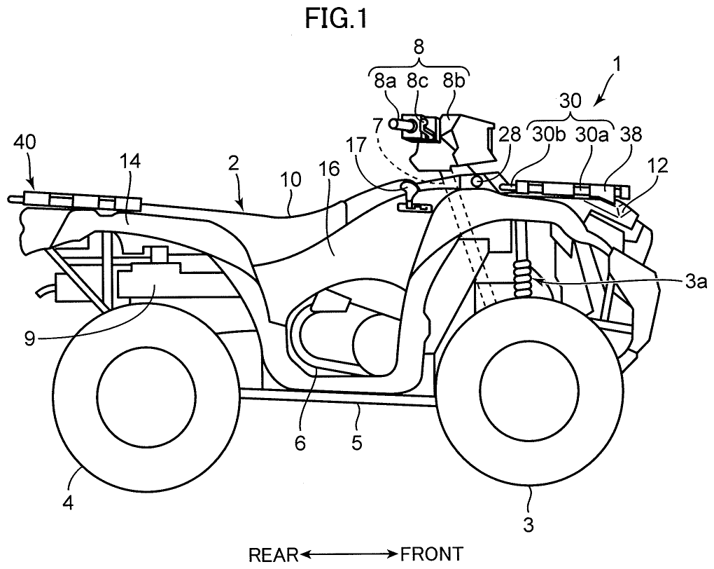

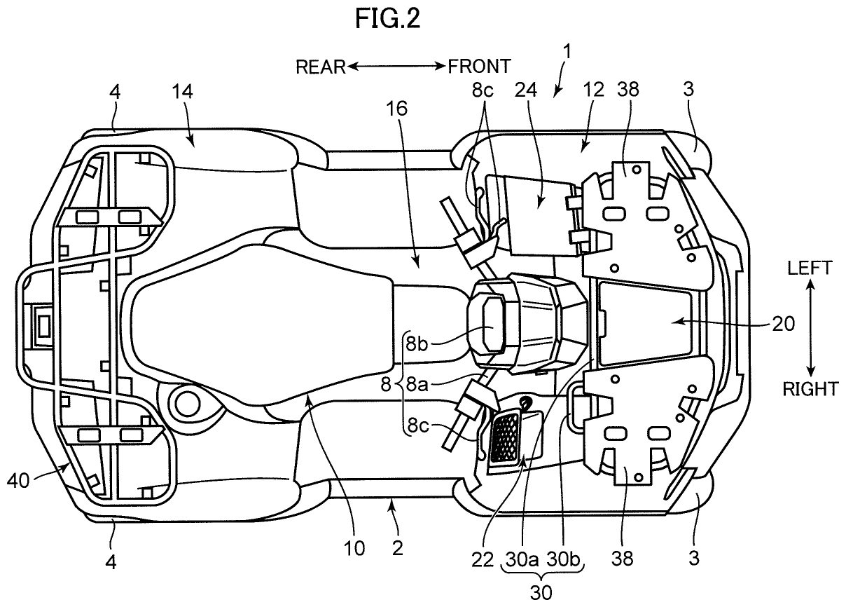

FIG. 1 is a side view of a saddle-type four-wheel vehicle 1 according to one embodiment of the present disclosure, and FIG. 2 is a plan view of the saddle-type four-wheel vehicle 1. The saddle-type four-wheel vehicle 1 is a saddle-type vehicle that is also called an ATV and is suitable for traveling on an irregular ground. The saddle-type four-wheel vehicle 1 (hereinafter, called ATV 1) includes a vehicle body 2 including a vehicle body frame 5 and covers, a power unit suspended from the vehicle body 2 and including an engine 6, and a fuel tank 9 attached to the vehicle body 2 and storing fuel to be supplied to the engine 6.

The vehicle body frame 5 is formed of a welding assembly with a pipe member such as a steel pipe. A front part of the vehicle body frame 5 is supported by a pair of left and right front wheels 3 via a suspension 3a, and a rear part of the vehicle body frame 5 is supported by the pair of left and right rear wheels 4 via a suspension not illustrated. The front wheels 3 and the rear wheels 4 are driven by the engine 6 via a transmission mechanism not illustrated such as a drive shaft. The ATV 1 travels by drive of the front wheels 3 and the rear wheels 4.

A steering shaft 7 is supported at the front part of the vehicle body frame 5. The steering shaft 7 is inclined rearward and extends in the up-down direction. A lower end of the steering shaft 7 is coupled to the left and right front wheels 3 via a tie rod not illustrated. A handle 8 is fixed to an upper end of the steering shaft 7. The handle 8 is positioned on the upper part of the vehicle body 2 and in the rear relative to the center of the front wheels 3.

A seat 10 is disposed in the rear of the handle 8 in the upper part of the vehicle body 2. The seat 10 has a saddle shape. By straddling this seat 10 and operating the handle 8, the occupant can steer the left and right front wheels 3. The handle 8 includes a handlebar 8a fixed to the steering shaft 7 and extending in the left-right direction, display apparatuses 8b provided at the center of the handlebar 8a, and an operation lever 8c such as an accelerator and a brake provided at each of both ends of the handlebar 8a. By operating these operation levers 8c, the occupant can control the travel speed of the ATV 1.

The ATV 1 includes a front fender 12, a rear fender 14, and a vehicle body cover 16. The front fender 12, the rear fender 14, and the vehicle body cover 16 are the covers made of resin or metal constituting the vehicle body 2 together with the vehicle body frame 5, and are fixed to the vehicle body frame 5.

The front fender 12 is provided so as to cover the left and right front wheels 3 and a part between the both front wheels 3 from above. The rear fender 14 is provided so as to cover the left and right rear wheels 4 and a part between the both rear wheels 4 from above. The vehicle body cover 16 is disposed between the front fender 12 and the rear fender 14 in the front-rear direction of the ATV 1 and is provided so as to cover the power unit and the peripheral part thereof.

A front carrier 30 is disposed in the front of the handle 8. A rear carrier 40 is disposed in the rear of the seat 10. The front carrier 30 and the rear carrier 40 are configured by a welding assembly of a pipe member such as a steel pipe. The front carrier 30 is fixed to the front part of the vehicle body frame 5, and the rear carrier 40 is fixed to the rear part of the vehicle body frame 5. By placing a load on the front carrier 30 and the rear carrier 40, it becomes possible to transport the load by the ATV 1.

### [Detailed Structure of Vehicle Front Part]

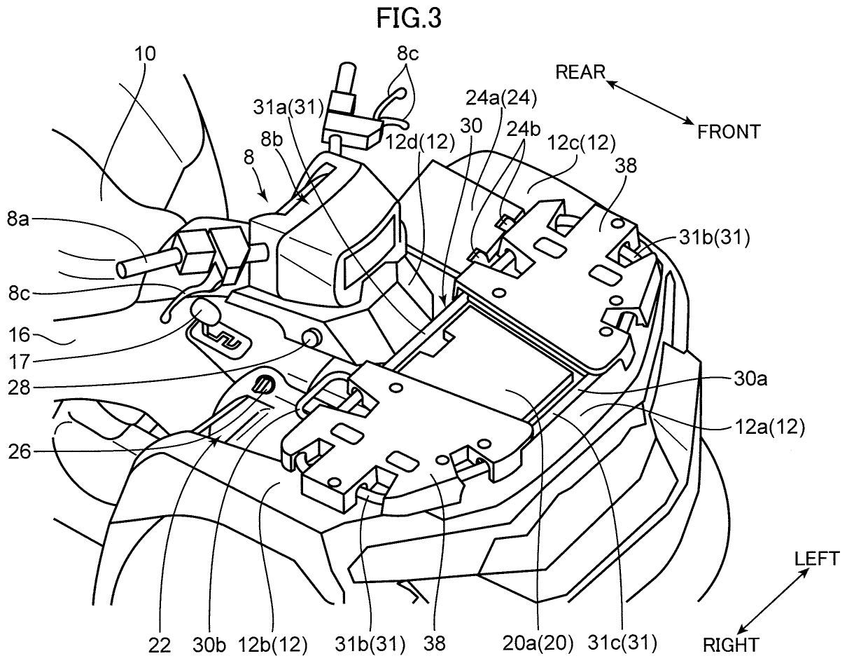

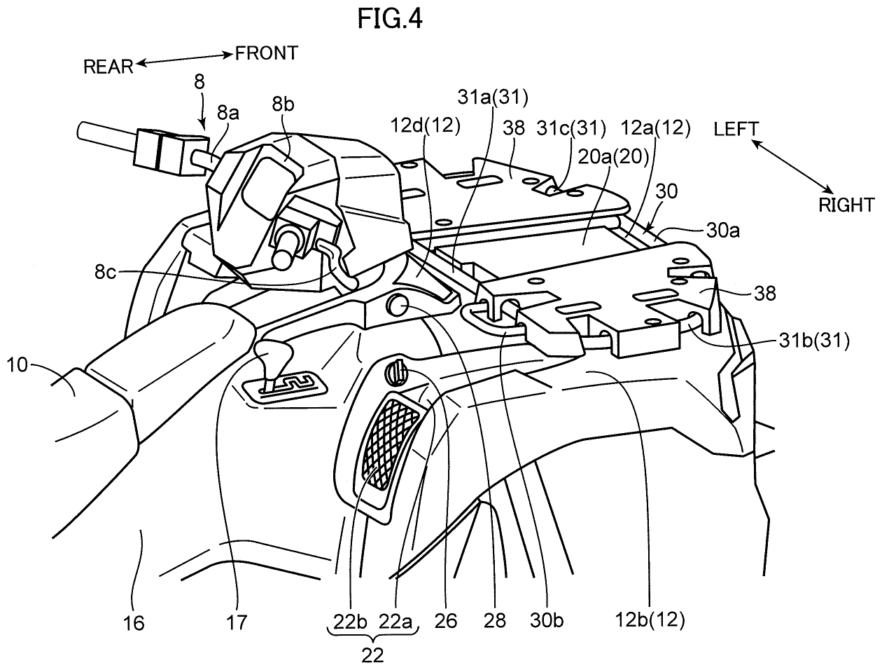

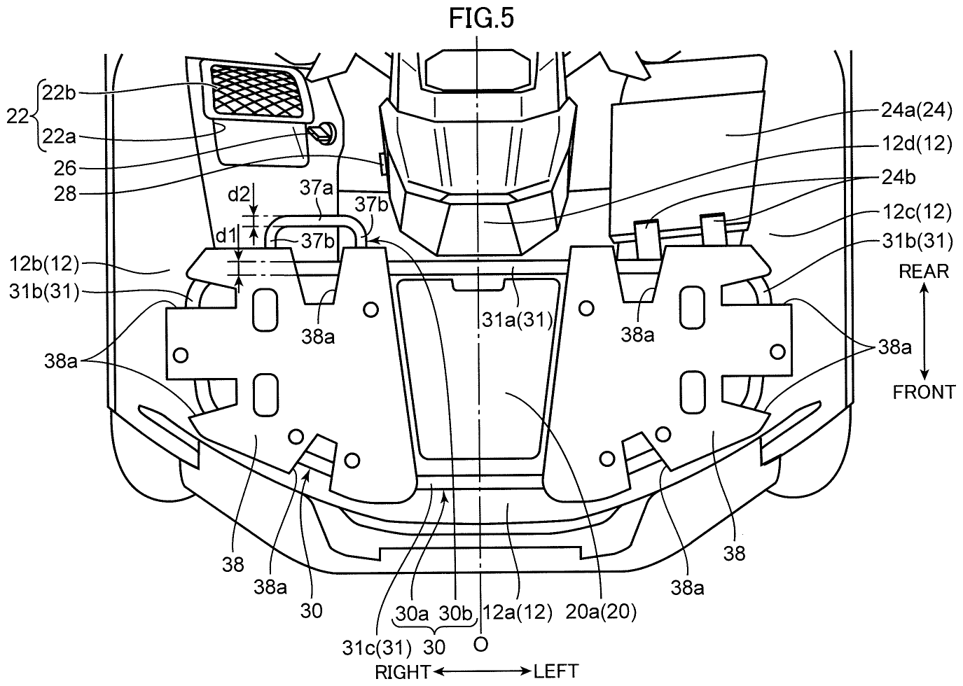

FIGS. 3 and 4 are front perspective views of the ATV 1. Specifically, FIG. 3 is a perspective view of the front part of the ATV 1 as viewed from diagonally front right, and FIG. 4 is a perspective view of the front part of the ATV 1 as viewed from diagonally rear right. FIG. 5 is a front plan view of the ATV 1.

The front part of the vehicle body 2 includes the front fender 12 covering the left and right front wheels 3 and a part between the both front wheels 3 from above. The front fender 12 includes a center region part 12a, a right side region part 12b, a left side region part 12c, and a handle peripheral part 12d.

The center region part 12a covers a center part in the vehicle width direction in the front of the handle 8, that is, a part between the left and right front wheels 3. The right side region part 12b is positioned on the right of the center region part 12a and mainly covers the front wheel 3 on the right side. The left side region part 12c is positioned on the left of the center region part 12a and mainly covers the front wheel 3 on the left side. The right side region part 12b and the left side region part 12c are provided so as to protrude and extend rearward relative to the center region part 12a. The handle peripheral part 12d is positioned in the rear of the center region part 12a, and adjacent to each of the center region part 12a, the right side region part 12b, and the left side region part 12c, and covers the peripheral part of the steering shaft 7.

The front fender 12 is provided with three storage parts 20 to 24 (a first storage part 20, a second storage part 22, and a third storage part 24) that can store small items. Specifically, the center region part 12a is provided with the first storage part 20, the right side region part 12b is provided with the second storage part 22, and the left side region part 12c is provided with the third storage part 24.

The first storage part 20 includes a recess part not illustrated having a rectangular shape in plan view and opening upward, and a lid member 20a detachably closing the opening (storage port) of this recess part. The first storage part 20 can be used for storage of, for example, maintenance tools, a traction rope, and the like.

The second storage part 22 is provided at a rear end part of the right side region part 12b. The second storage part 22 is a pocket-shaped storage part opening upward. Specifically, as illustrated in FIG. 4, the rear end part of the right side region part 12b is formed to curve rearward and downward from the front toward the rear along the front wheel 3. The second storage part 22 includes a groove part 22a extending in an up-down direction provided along this curved part and an elastic sheet 22b that is stretchable, for example, covering this groove part 22a. The second storage part 22 can be used for storage of articles frequently taken in and out such as plastic bottles.

An ignition switch 26 is disposed on a side of the second storage part 22 in the right side region part 12b, specifically, the left side of the opening (storage port) of the second storage part 22. The ignition switch 26 is a switch operated when the ATV 1 is started and stopped. The occupant can start the engine 6 by turning on the ignition switch 26 and operating a start button not illustrated that is included in the handle 8. The occupant can stop the engine 6 by turning off the ignition switch 26.

A shift lever 17 is disposed in the rear of the ignition switch 26. The shift lever 17 performs switching operation of a transmission. The shift lever 17 is included in the vehicle body cover 16 provided adjacent to the rear of the front fender 12.

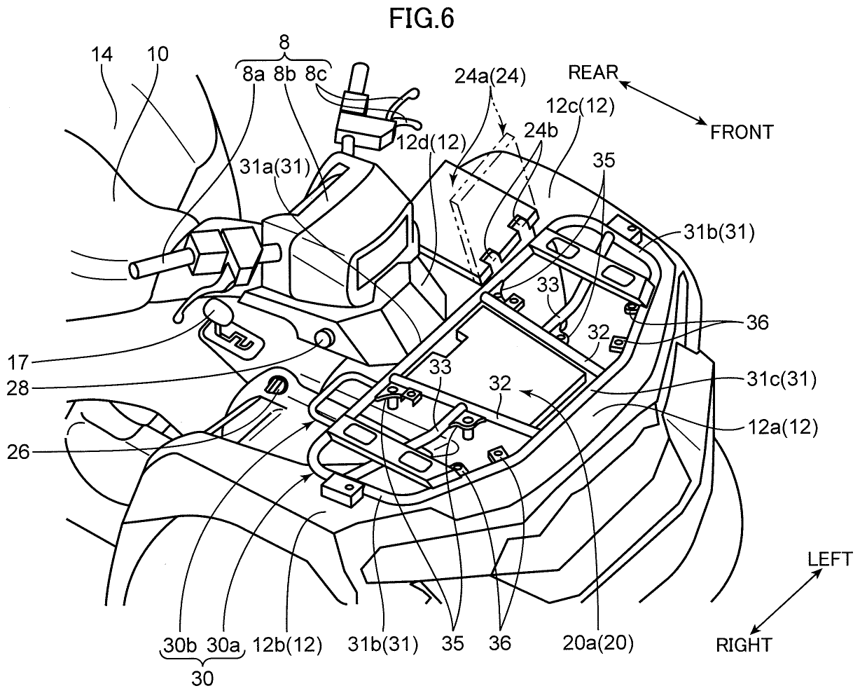

The third storage part 24 (an example of an opening part opened and closed by the lid member) is provided at a rear end part of the left side region part 12c. The third storage part 24 includes a recess part not illustrated having a rectangular shape in plan view and opening upward, and a lid member 24a swingably closing an opening (storage port) of this recess part. The lid member 24a is provided swingably with a hinge 24b provided at a front end part thereof as a fulcrum. Specifically, the lid member 24a is provided swingably between a lowered attitude in which the storage port is closed and an upright attitude in which the storage port is opened (see FIG. 6). The third storage part 24 can be used as, for example, a glove box that stores gloves to be used during traveling.

The handle peripheral part 12d is positioned below the handle 8 as illustrated in FIGS. 3 and 4 and has a U shape in plan view surrounding the steering shaft 7 from the front side, the right side, and the left side. The handle peripheral part 12d is formed so as to rise upward relative to an upper surface of the other parts (12a, 12b, and 12c) of the front fender 12.

A power socket 28 is disposed on a side surface on the right side of the handle peripheral part 12d. That is, the power socket 28 is disposed on the same side as the ignition switch 26 in the vehicle width direction. Specifically, as illustrated in FIG. 5, the power socket 28 and the ignition switch 26 are disposed on the right side relative to a center position O (in this example, the position of an axis extending in the front-rear direction through the position of the steering shaft 7) of the vehicle body 2 in the vehicle width direction.

The power socket 28 is vehicle equipment that enables power (power source) supply from the ATV 1 to the outside. An auxiliary power outlet is a typical example of the power socket 28. Although a detailed view is omitted, the power socket 28 includes a socket body and a lid member that closes a connection port of the socket body. In use, by removing the lid member and inserting a terminal of a connection cord into the socket body, it becomes possible to supply power to the outside through the connection cord.

The front carrier 30 is disposed above the front fender 12 already mentioned. The upper surface of the front fender 12 is formed of a substantially flat surface, and the front carrier 30 is disposed substantially horizontally along the upper surface of the front fender 12 at a position lower than the handle 8.

As illustrated in FIGS. 1 to 5, the front carrier 30 has a substantially plate-like structure that is flat in the up-down direction. The front carrier 30 is applied with a carrier cover 38. The carrier cover 38 is a resin or metal attachment member detachably applied to the front carrier 30. The front carrier 30 is formed of a welding assembly of pipe member as already mentioned, and has little planar part. Therefore, placing stability of the load on the front carrier 30 is achieved by applying the carrier cover 38 to the front carrier 30 to add a planar part.

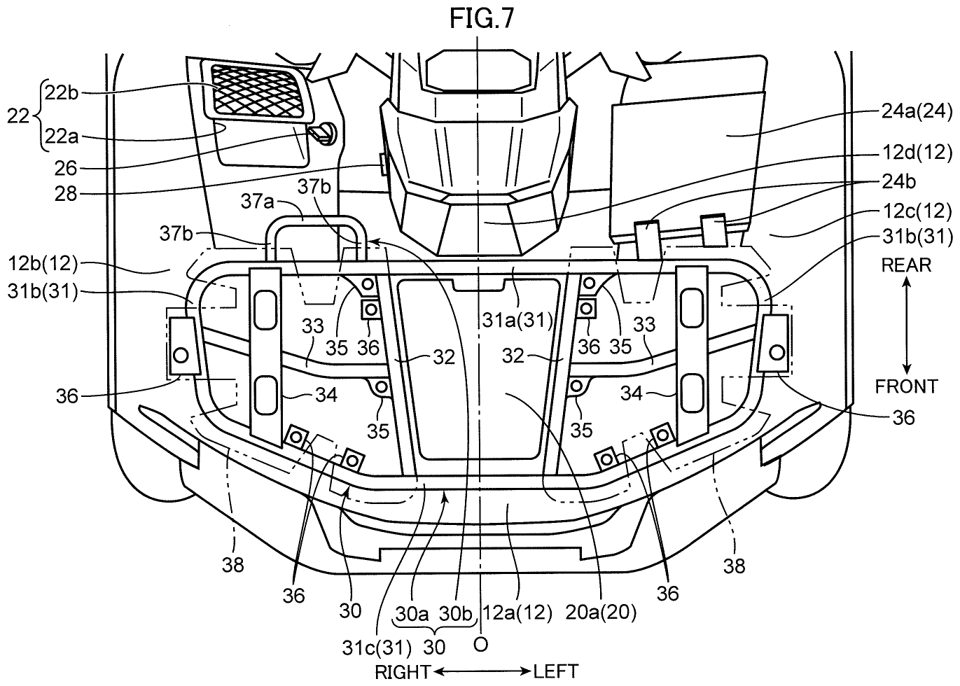

FIGS. 6 and 7 are front perspective views of the ATV 1 in a state where the carrier cover 38 is removed from the front carrier 30. FIG. 6 corresponds to FIG. 3, and FIG. 7 corresponds to FIG. 5.

The front carrier 30 includes a body part 30a extending in the width direction in the front of the handle 8 and an attachment bar 30b protruding rearward (i.e., the handle 8 side) from the body part 30a. The body part 30a is a part for mainly placing the load in the front carrier 30, and the attachment bar 30b is a preliminary part of the front carrier 30 that can be used as an attachment part of various auxiliary apparatuses. A GPS, a camera, a light, a speaker, and the like are examples of the auxiliary apparatus.

The body part 30a includes an outline part 31 having a loop shape elongated in the width direction, and beam parts 32 and 33 and a reinforcing part 34 that are disposed inside (inner peripheral side) of the outline part 31 and joined to respective parts of the outline part 31.

The outline part 31 includes a rear piece part 31a, a pair of left and right side parts 31b, and a front piece part 31c. The rear piece part 31a linearly extends in the vehicle width direction at a position adjacent to the front of the handle peripheral part 12d of the front fender 12 and the third storage part 24. The pair of side parts 31b each extend forward from both ends of the rear piece part 31a. The front piece part 31c extends in the vehicle width direction in the front of the rear piece part 31a and connects the front ends of the side parts 31b together. With this configuration, the outline part 31 is formed in a substantially rectangular loop shape in plan view. Then, a pair of the left and right longitudinal beam parts 32 extending in the front-rear direction at positions different from each other in the width direction of the outline part 31 and connecting the rear piece part 31a and the front piece part 31c, and a pair of left and right lateral beam parts 33 extending in the width direction and connecting the longitudinal beam parts 32 and the side part 31b are provided. Furthermore, a pair of the reinforcing parts 34 extending in the front-rear direction and connecting the rear piece part 31a, the lateral beam part 33, and the front piece part 31c is provided at positions between the longitudinal beam parts 32 and the side part 31b.

The body part 30a is formed of a pipe member having a circular cross section with the same pipe diameter except for the reinforcing part 34. The reinforcing part 34 is formed of a press-molded member made of a plate material.

As illustrated in FIG. 7, the body part 30a is provided with a plurality of brackets 35. Specifically, the bracket 35 is provided so as to be adjacent to a joint between each of the longitudinal beam parts 32 and the rear piece part 31a and a joint between each of the longitudinal beam parts 32 and the lateral beam part 33. The bracket 35 is a fixing portion of the front carrier 30 with respect to the vehicle body frame 5. That is, each of the brackets 35 is fastened to the vehicle body frame 5 with a bolt nut through an opening part not illustrated formed in the front fender 12. With this configuration, the front carrier 30 is fixed to the vehicle body frame 5.

The region between the left and right longitudinal beam parts 32 constituting the body part 30a is positioned above the center region part 12a of the front fender 12, more specifically, above the first storage part 20. The rear piece part 31a of the outline part 31 is positioned between the handle peripheral part 12d of the front fender 12 and the first storage part 20, and the front piece part 31c is positioned in the front of the first storage part 20. Therefore, the upper part of the first storage part 20 of the front fender 12 is opened so that the first storage part 20 can be opened and closed, that is, the lid member 20a can be attached and detached.

A region of the body part 30a on the vehicle outside (right side) relative to the longitudinal beam part 32 on the right side is positioned above the front part of the right side region part 12b of the front fender 12. A region of the body part 30a on the vehicle outside (left side) relative to the longitudinal beam part 32 on the left side is positioned above the front part of the left side region part 12c of the front fender 12.

The center position of the front carrier 30 in the vehicle width direction coincides with the center position O of the vehicle width direction of the ATV 1 (the vehicle body 2). As illustrated in FIG. 7, the attachment bar 30b is provided at a position on the right side relative to the center position of the body part 30a in the vehicle width direction, more specifically, a position on the vehicle outside (right side) of the longitudinal beam part 32 on the right side. That is, the attachment bar 30b is provided on the same side as the power socket 28 in the vehicle width direction.

The attachment bar 30b is formed of a pipe member having a circular cross section, and is provided so as to protrude substantially horizontally rearward from the body part 30a. The attachment bar 30b has a U shape in plan view including a lateral shaft part 37a extending linearly in the left-right direction along the rear piece part 31a of the body part 30a (outline part 31), and a pair of longitudinal shaft parts 37b extending forward from both ends of the lateral shaft part 37a. The lateral shaft part 37a is provided substantially parallel to the rear piece part 31a. The shaft length of the longitudinal shaft part 37b is set to be shorter than the shaft length of the lateral shaft part 37a. The attachment bar 30b is formed by bending a pipe member, and is integrally provided with the body part 30a by joining each longitudinal shaft part 37b to the rear piece part 31a of the outline part 31. The shaft length of the longitudinal shaft part 37b may be set to be longer than the shaft length of the lateral shaft part 37a.

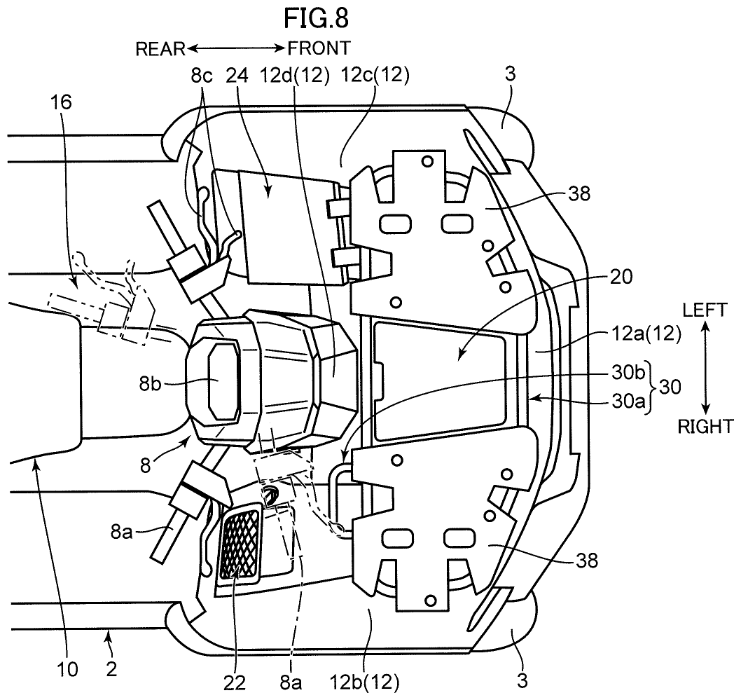

FIG. 8 is a front plan view of the ATV 1 illustrating the rotation region of the handlebar 8a. The two-dot chain line in FIG. 8 indicates a state in which the handle 8 is turned to the leftmost, that is, a state in which the handlebar 8a is closest to the attachment bar 30b. As illustrated in this figure, the attachment bar 30b is provided so as to be positioned at least outside the rotation region of the handlebar 8a of the handle 8 in plan view of the ATV 1.

As illustrated in FIGS. 1 and 4, the attachment bar 30b is disposed at a position close to the power socket 28 in the up-down direction (height direction) of the ATV 1. In this example, the attachment bar 30b is disposed at a position slightly lower than power socket 28. Also in plan view of the ATV 1, the attachment bar 30b is disposed at a position close to the power socket 28. In this example, as illustrated in FIGS. 5 and 7, the attachment bar 30b is disposed so as to be adjacent to a diagonally front side of the power socket 28, specifically, diagonally front right.

As already mentioned, both the body part 30a (excluding the reinforcing part 34) and the attachment bar 30b are formed of pipe members having circular cross sections, but a pipe diameter d2 of the attachment bar 30b is set smaller than a pipe diameter d1 of the body part 30a (see FIG. 5).

The carrier cover 38 is applied to the front carrier 30 thus configured.

As illustrated in FIGS. 5 and 7, the carrier cover 38 is formed so as to cover left and right end parts of the front carrier 30 except for the attachment bar 30b from above. Specifically, the carrier cover 38 is formed so as to cover regions on the left and right outsides relative to the longitudinal beam part 32 of the body part 30a. The carrier cover 38 has a substantially flat upper surface. The carrier cover 38 is fixed to the front carrier 30 by being fastened with bolt nuts to a plurality of brackets 36 provided on the body part 30a.

The carrier cover 38 is formed with a plurality of cutout parts 38a arranged side by side along the outline part 31 of the body part 30a. The cutout part 38a is for exposing the outline part 31. That is, by attaching a fixing belt to the outline part 31 exposed through the cutout part 38a, it is possible to fix the load to the front carrier 30 using the fixing belt.

Since the carrier cover 38 covers the left and right end parts of the front carrier 30 excluding the attachment bar 30b from above as already mentioned, the attachment bar 30b itself is exposed without being covered with the carrier cover 38.

### [Actions and Effects]

As described above, in the present embodiment, the front carrier 30 is disposed in the front of the handle 8 in the ATV 1 (vehicle body 2), and this front carrier 30 includes the attachment bar 30b protruding rearward from the body part 30a in addition to the body part 30a for placing the load. According to such configuration, the auxiliary apparatus can be attached to the front carrier 30 without any difficulty and used without sacrificing the loading amount of the load on the front carrier 30.

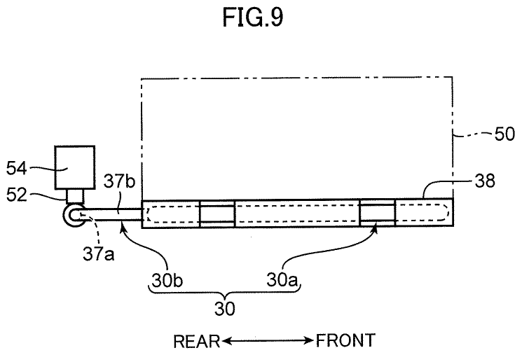

FIG. 9 is a schematic side view illustrating an example of the use state of the front carrier. That is, as illustrated in FIG. 9, an auxiliary apparatus 54 can be attached to the front carrier 30 using the attachment bar 30b in a state of placing the load 50 on the body part 30a of the front carrier 30. In this case, since the attachment bar 30b includes the lateral shaft part 37a extending in the vehicle width direction, as illustrated in the drawing, the lateral shaft part 37a can be attached with a holder member 52, and the auxiliary apparatus 54 can be held by this holder member 52. Therefore, according to the present embodiment, it is possible to solve the problems that the auxiliary apparatus 54 attached to the front carrier 30 becomes an obstacle in placing of the load 50 and that it becomes difficult to attach the auxiliary apparatus 54 to the front carrier 30 due to the load 50 to be placed.

The attachment bar 30b is provided at a position deviated to one side (the right side in the present embodiment) in the vehicle width direction relative to the center position O of the vehicle body 2. Therefore, there is an advantage of being able to ensure well visibility and operability of the auxiliary apparatus 54 attached to the attachment bar 30b.

That is, in the ATV 1 of the present embodiment, the center of the handle 8 includes the display apparatuses 8b. Therefore, if the attachment bar 30b is disposed at the center position O of the vehicle body 2, the display apparatuses 8b may become an obstacle in visual recognition and operation of the auxiliary apparatus 54 attached to the attachment bar 30b. However, since the attachment bar 30b is provided at a position deviated to one side relative to the center position O of the vehicle body 2, the auxiliary apparatus 54 attached to the attachment bar 30b is disposed at a position deviated from the display apparatuses 8b. As a result, the display apparatuses 8b become less likely to be an obstacle in visual recognition and operation of the auxiliary apparatus 54. Therefore, even in a case of requiring visual recognition and operation of the auxiliary apparatus 54, it is possible to ensure well visibility and operability thereof.

In the present embodiment, since the vehicle body 2 includes the power socket 28, when the auxiliary apparatus 54 is an electric apparatus, electric power can be supplied from the vehicle body 2 to the auxiliary apparatus 54. Therefore, for example, as compared with a case of using the auxiliary apparatus 54 only with a built-in battery, it becomes possible to use the auxiliary apparatus 54 more continuously.

In particular, the power socket 28 is provided on the same side as the attachment bar 30b in the vehicle width direction, that is, on the same side (the right side in the present embodiment) as the power socket 28 with respect to the center position O of the vehicle body 2. Moreover, the attachment bar 30b and the power socket 28 are disposed at heights close to each other. The attachment bar 30b is provided adjacent to the diagonally front of the power socket 28. Therefore, the auxiliary apparatus 54 attached to attachment bar 30b and the power socket 28 are close in distance, and the auxiliary apparatus 54 and the power socket 28 can be connected with a relatively short connection cord without difficulty.

In the present embodiment, both the ignition switch 26 and the power socket 28 are provided on the same side (the right side in the present embodiment) with respect to the center position O of the vehicle body 2, and the ignition switch 26 is disposed adjacent to the right side of the power socket 28 as illustrated in FIG. 5. That is, the attachment bar 30b is provided on the same side as the ignition switch 26 and the power socket 28 with respect to the center position O of the vehicle body 2. According to the present embodiment, for example, after the auxiliary apparatus 54 attached to the attachment bar 30b is connected to the power socket 28, it is possible to quickly shift to vehicle start operation by the ignition switch 26. Therefore, there is an advantage of improving workability of preparation before traveling of the ATV 1.

In the present embodiment, the attachment bar 30b is provided on the side opposite to the third storage part 24 of the front fender 12 in the vehicle width direction, that is, on the side (right side) opposite to the third storage part 24 with respect to the center position O of the vehicle body 2. Therefore, when a stored object is taken in or out of the third storage part 24, the lid member 24a does not interfere with the attachment bar 30b or the auxiliary apparatus 54 attached to this. There is no inconvenience that a hand unexpectedly comes into contact with the attachment bar 30b when opening and closing the lid member 24a. The attachment bar 30b is provided on the same side as the second storage part 22 of the front fender 12, but as illustrated in FIGS. 4 and 5, the attachment bar 30b is disposed in the front relative to the second storage part 22. Moreover, the second storage part 22 is a pocket-type storage part as already mentioned, and the attachment bar 30b and the auxiliary apparatus 54 attached to this do not become an obstacle when the stored object is taken in and out. Therefore, according to the present embodiment, it is possible to take in and out well the stored object with respect to the second storage part 22 and the third storage part 24 while providing the front carrier 30 with the attachment bar 30b.

In the present embodiment, the front carrier 30 is disposed at a position lower than the handle 8, and in the front carrier 30, the attachment bar 30b protrudes substantially horizontally rearward from the body part 30a. Moreover, in plan view of the ATV 1, the attachment bar 30b is disposed outside the rotation region of the handlebar 8a as already mentioned. Therefore, the auxiliary apparatus 54 attached to the attachment bar 30b and the handlebar 8a do not interfere with each other.

In the present embodiment, the front carrier 30 is mainly formed of a pipe member, but as already mentioned, the pipe diameter d2 of the attachment bar 30b is set smaller than the pipe diameter d1 of the body part 30a. According to such configuration, the front carrier 30 can be reasonably provided with the attachment bar 30b. That is, the attachment bar 30b is lower in required strength than the body part 30a for placing the load. Therefore, according to the configuration of the embodiment, there is an advantage of being able to enhance the attachment bar 30b in terms of the degree of freedom in shape and workability due to reduction in the diameter thereof while appropriately ensuring the body part 30a with the strength necessary for placing the load.

In the present embodiment, a planar part is added to the front carrier 30 by applying the front carrier 30 with the carrier cover 38. Therefore, as compared with the case where the carrier cover 38 is not applied, the load can be more stably placed with respect to the front carrier 30. In this case, since the attachment bar 30b is provided so as to be exposed to the outside of the carrier cover 38, the auxiliary apparatus 54 can be attached to the front carrier 30 without difficulty using the attachment bar 30b even in a state where the front carrier 30 is applied with the carrier cover 38.

### [Modifications]

In the above embodiment, the attachment bar 30b is disposed on the right side relative to the center position O of the vehicle body 2 in the vehicle width direction. However, the attachment bar 30b may be disposed on the left side relative to the center position O of the vehicle body 2, or may be disposed on each of both left and right sides of the center position O. For example, in a case where there is no risk of interference with the lid member 24a of the third storage part 24 or in a case of an aspect in which the front fender 12 has no third storage part 24, the attachment bar 30b may be disposed on the left side relative to the center position O of the vehicle body 2. The attachment bar 30b can also be disposed at the center position O of the vehicle body 2.

In the above embodiment, the attachment bar 30b is provided so as to protrude substantially horizontally rearward from the body part 30a. However, the form of the attachment bar 30b is not limited to this. The attachment bar 30b may be provided so as to protrude diagonally upward or diagonally downward from the body part 30a rearward, for example.

In the above embodiment, the attachment bar 30b has a U shape in plan view, but the shape of the attachment bar 30b is not limited to this. For example, the attachment bar 30b may have a T shape in plan view including a lateral shaft part extending in the width direction and a longitudinal shaft part extending forward from a longitudinal center part of the lateral shaft part and connected to the outline part 31 (the rear piece part 31a).

In the above embodiment, the handle 8 is rotatably supported by the vehicle body frame 5 via the steering shaft 7, and the front carrier 30 is fixed to this vehicle body frame 5. That is, the ATV 1 has a configuration in which the front carrier 30 does not follow the rotation of the handle 8. However, the ATV 1 may have a configuration in which the front carrier 30 rotates integrally with the handle 8.

In the above embodiment, an example in which the attachment bar 30b is provided on the front carrier 30 has been described, but it is also conceivable of providing the attachment bar on the rear carrier 40. In this case, the rear carrier 40 can have a configuration including a body part extending in the width direction in the rear of the seat 10, for example, and an attachment bar protruding forward (the handle 8 side) from the body part.

In the above embodiment, the ATV 1 has been described as an example of the vehicle. However, the vehicle is not limited to the ATV 1. The vehicle may be a saddle-type vehicle other than the ATV 1 or a vehicle other than the saddle-type vehicle.

### [Summary]

The above-described embodiment and its modifications include the following disclosure.

A vehicle according to one aspect of the present disclosure includes: a vehicle body; a handle provided on an upper part of the vehicle body; and a carrier provided in the front of the handle or in the rear relative to the handle. The carrier includes a body part for placing a load and an attachment bar protruding toward a handle side from the body part.

According to the present disclosure, in addition to the body part for placing the load, the carrier is provided with the attachment bar protruding toward the handle side from the body part. Therefore, while placing the body part with the load, it is possible to attach various auxiliary apparatuses to the carrier without difficulty using the attachment bar. As a result, it becomes possible to use the auxiliary apparatus without sacrificing the loading amount of the load, and the convenience is improved.

The carrier may be provided in the front of the handle, the body part may extend in the vehicle width direction, and the attachment bar may be disposed on at least one side of a right side and a left side relative to a center position in a vehicle width direction of the vehicle body.

According to this aspect, it becomes possible to ensure better visibility and operability of the auxiliary apparatus attached to the attachment bar.

Preferably, the vehicle body includes a power socket, and the power socket is disposed at a position adjacent to the attachment bar.

In this aspect, it becomes possible to supply power (power source) from the vehicle body to the auxiliary apparatus attached to the attachment bar. Therefore, it is convenient when the auxiliary apparatus is an electric apparatus. In particular, since the power socket is disposed at a position adjacent to the attachment bar, the auxiliary apparatus and the power socket are close in distance, and can be connected to each other with a relatively short connection cord.

The vehicle body may include a power socket, and the power socket may be included on at least a side on which the attachment bar is disposed, of the right side and the left side.

Also in a case of this aspect, power (power source) can be supplied from the vehicle body to the auxiliary apparatus attached to the attachment bar.

The vehicle body may include a switch operated when the vehicle is started, and the switch may be disposed at a position adjacent to the power socket.

In this aspect, the switch operated when the vehicle is started is disposed at a position adjacent to the power socket. That is, the attachment bar is disposed in the vicinity of the switch. Therefore, for example, after the auxiliary apparatus attached to the attachment bar is connected to the power socket with the connection cord, it is possible to quickly shift to the vehicle start operation by the switch. As a result, workability of preparation before traveling is improved.

The carrier may be formed of a pipe member, and a pipe diameter of the attachment bar may be configured to be smaller than a pipe diameter of the body part.

According to this aspect, it is possible to improve the degree of freedom of the shape and the workability of the attachment bar while ensuring the strength of the body part for placing the load.

The vehicle may further include a carrier cover applied to the carrier and covering the carrier from above, in which the attachment bar may be provided so as to be exposed outward from the carrier cover.

In this aspect, since the attachment bar is provided so as to be exposed outward of the carrier cover, even in a configuration in which the carrier cover is applied to the carrier, the auxiliary apparatus can be applied to the attachment bar without difficulty.

The vehicle body may include a vehicle body frame, the handle may be rotatably supported by the vehicle body frame, and the carrier may be fixed to the vehicle body frame in the front of the handle.

According to this aspect, it becomes possible to attach, using the attachment bar, the auxiliary apparatus to the carrier integrally fixed to the vehicle body frame.

Preferably, the handle includes a handlebar gripped by an occupant, and the attachment bar is disposed at least outside a region where the handlebar rotates in plan view.

In this aspect, since the attachment bar is disposed outside the rotation region of the handlebar, it is possible to avoid the handlebar from interfering with the attachment bar and the auxiliary apparatus attached to the attachment bar and the handlebar from interfering with each other in a case where the vehicle is of saddle-type.

The body part may be disposed at a position lower than the handle, and the attachment bar may protrude horizontally from the body part.

Also in this aspect, in a case where the vehicle is of saddle-type, it is possible to avoid interference between the auxiliary apparatus attached to the attachment bar and the handlebar.

The vehicle body includes an opening part opened and closed by a lid member on a rear of the carrier, on the right side or the left side, and the attachment bar is disposed on a side opposite to a side on which the opening part is included, of the right side and the left side. The opening part opened and closed by the lid member is a storage part that can store articles, an inspection port used for inspection, or the like.

In this aspect, since the attachment bar is disposed on the side opposite to the side where the opening part is included in the vehicle width direction of the vehicle body, it is possible to avoid the lid member from interfering with the attachment bar when the lid member is opened and closed, and a hand from unexpectedly coming into contact with the attachment bar when the lid member is opened and closed.

1. A vehicle comprising:
a vehicle body;
a handle provided on an upper part of the vehicle body; and
a carrier provided in a front of the handle or in a rear relative to the handle,
wherein the carrier includes a body part for placing a load and an attachment bar protruding toward a handle side from the body part.

2. The vehicle according to claim 1, wherein
the carrier is provided in the front of the handle,
the body part extends in a vehicle width direction, and
the attachment bar is disposed on at least one side of a right side and a left side relative to a center position in a vehicle width direction of the vehicle body.

3. The vehicle according to claim 1, wherein
the vehicle body includes a power socket, and
the power socket is disposed at a position adjacent to the attachment bar.

4. The vehicle according to claim 2, wherein
the vehicle body includes a power socket, and
the power socket is included on at least a side on which the attachment bar is disposed, of the right side and the left side.

5. The vehicle according to claim 3, wherein
the vehicle body includes a switch operated when the vehicle is started, and
the switch is disposed at a position adjacent to the power socket.

6. The vehicle according to claim 1, wherein
the carrier is formed of a pipe member, and
a pipe diameter of the attachment bar is smaller than a pipe diameter of the body part.

7. The vehicle according to claim 1, further comprising:
a carrier cover applied to the carrier and covering the carrier from above, wherein
the attachment bar is provided so as to be exposed outward from the carrier cover.

8. The saddle-type four-wheel vehicle according to claim 2, wherein
the vehicle body includes a vehicle body frame,
the handle is rotatably supported by the vehicle body frame, and
the carrier is fixed to the vehicle body frame in the front of the handle.

9. The vehicle according to claim 8, wherein
the handle includes a handlebar gripped by an occupant, and
the attachment bar is disposed at least outside a region where the handlebar rotates in plan view.

10. The vehicle according to claim 8, wherein
the body part is disposed at a position lower than the handle, and
the attachment bar protrudes horizontally from the body part.

11. The vehicle according to claim 2, wherein
the vehicle body includes an opening part opened and closed by a lid member on a rear of the carrier, on the right side or the left side, and
the attachment bar is disposed on a side opposite to a side on which the opening part is included, of the right side and the left side.
